(19) United States
(12) Patent Application Publication
(10) Pub. No.: US 2011/0265029 A1
(43) Pub. Date: Oct. 27, 2011

(54) Method for Providing User Interface in Electric Device and Device thereof

(76) Inventor: Yong-Seok Jeong, Gwangjoo (KR)

(21) Appl. No.: 11/988,850

(22) PCT Filed: Jun. 9, 2006
(86) PCT No.: PCT/KR2006/002217

§ 371 Date: Jul. 11, 2011

(30) Foreign Application Priority Data
Jun. 10, 2005 (KR) 10-2005-0049592

(51) Int. Cl. G06F 3/048

(52) U.S. Cl. 715/784; 715/781

(57) ABSTRACT

The present invention discloses a method of providing a user interface in an electronic device and a device thereof. According to embodiments of the present invention, the method of providing a user interface by an electronic device having a display unit comprises: dividing an entire screen or a part of the display unit into a plurality of domains, the display unit currently displaying visual information; recognizing from the plurality of domains a selection domain corresponding to an input signal; and recognizing control information corresponding to the selection domain and processing the control information. According to the present invention, the method and device for providing a user interface in an electronic device can input selection information by selecting a domain on a screen, which is sectioned in a predetermined manner

### TECHNICAL FIELD

The present invention is related to a user interface, more specifically to a method and a device for providing a user interface in an electronic device.

### BACKGROUND ART

For entering an input by selecting what is displayed on the screen in an electronic device such as a mobile phone, a PDA (personal digital assistant), and a personal computer, input methods such as touch-screen, arrow keys, and a cursor by a mouse, are currently used. Portable terminals, such as mobile phones and PDAs, in particular, utilize text input or image (e.g. icons and image links) menu, which expresses specific functions. Most portable terminals use touch-screen or arrow keys for their user interface means for inputting selected information. For personal computers, the cursor means by use of a mouse is commonly used. For digital TVs and analog TVs, it is common to select and activate a function on a specific location by utilizing input means, such as a keyboard, short-cut keys for which specific functions are predetermined, text input, or cursor movement through a mouse. The touch-screen method also is a type of cursor method that makes the selection directly on the screen.

The user interface is imperative for inputting selected information in two-way communication. As the user environment for personal computers becomes more graphic, the user interface means has transformed from the keyboard input method to the on-screen input method using the mouse. In the mouse method, the cursor can be moved using the mouse, and the selected information can be inputted by clicking a predetermined button. The touch-screen method is widely used, as an alternative to the inconvenience of using the mouse, in bulletins in department stores and malls, kiosks in terminals, buildings, bookstores, and public places, and PDAs. In the touch-screen method, touching a domain on the screen with a finger or a stylus, without having to move the cursor, selects the function corresponding to the domain of the screen.

The touch-screen method, however, is not practical for terminals whose screen is mainly used for displaying multimedia images because use of the touch-screen method disrupts the viewing of the image. Stains or oil from the finger also can make the image blurry. Besides, the screen has to be always within reachable distance. Image-displaying terminals are usually viewed from a distance, and thus using a mouse to move the cursor or touching the screen is not very practical. If the touch-screen method and the remote-control method were combined, it would be possible with a two-way digital TV to remotely move the cursor on the screen using the remote control and input the selected information. However, controlling the cursor on the screen using the remote control would still remain difficult, particularly for the elderly and children. Therefore, with the advent of the aging society, a user interface for simpler, easier input is needed more than ever.

Lately, portable terminals, which can be carried and operated in one hand, have become popular. It is not easy, however, to use the mouse to enter the selection with the hand holding the terminal. Even for portable terminals like a PDA, which has the touch-screen functionality and a larger screen, it is difficult cover every area of the screen with the hand holding the terminal. Thus, an electronic device that can be easily handled by one hand is called for.

### DISCLOSURE

### Technical Problem

Therefore, the present invention is contrived to solve above problems by providing a method and a device for providing a user interface in an electronic device that can input selection information by selecting a domain on a screen, which is sectioned in a predetermined manner.

The present invention also aims to provide a method and a device for providing a user interface in an electronic device that can conveniently input selection information by operating a number button, linked to a domain of a latticed screen, on a key pad or a remote control.

It is another object of the present invention to provide a method and a device for providing a user interface in an electronic device that can input selection information with the hand holding a terminal, such as a mobile phone or a PDA.

In another object of the present invention, a method and a device for providing a user interface in an electronic device can easily select a detailed domain by enlarging a desired domain of a screen.

Other objects of the present invention will become apparent through preferred embodiments described below.

### Technical Solution

In order to achieve the above objects, an aspect of the present invention features a method of providing a user interface in an electronic device having a display unit and a recorded medium recording a program executing the method thereof. The method comprises: (a) dividing an entire screen or a part of the display unit into a plurality of domains, the display unit currently displaying visual information; (b) recognizing from the plurality of domains a selection domain corresponding to an input signal; and (c) recognizing control information corresponding to the selection domain and processing the control information.

The screen can be divided into lattices corresponding to a keypad, which is disposed in the electronic device or on a corresponding remote control.

The number of the divided domains can be predetermined, configured to correspond to separately inputted information, or determined by control information inserted to correspond to the visual information.

The step (a) can comprise: recognizing location information of one or more pieces of control information corresponding to the visual information; and dividing each domain to correspond to the location information.

The step (b) can comprise: displaying the divided screen; receiving the input signal; recognizing a selection domain corresponding to the input signal; and displaying the selection domain in a predetermined format.

The step (c) can comprise: determining whether there are a plurality of control information corresponding to the selection domain; and, if there are a plurality of control information, re-dividing the selection domain, but processing the control information, only if a divided domain having one piece of control information is selected, hi addition, the re-divided selection domain can be enlarged or reduced.

In case the screen displays a plurality of windows, one selected active window can be divided. Each of the plurality of windows can be given an identification code, and a window, in the active window, having an identification code corresponding to an inputted signal can be selected.

In case the active window has a scroll bar, location information of each of the control information can have an initial value, and control information in accordance with the selection domain can be selected in accordance with the initial value and a displacement value corresponding to the movement of the scroll bar.

Each of the divided domains can have X, Y, and Z coordinates and can be three-dimensionally controlled.

In order to achieve the above objects, another aspect of the present invention features an electronic device providing a user interface through a display unit. The electronic device comprises: a selection domain recognizing unit, dividing an entire screen or a part of a screen currently displayed through the display unit into a plurality of domains, the display unit currently displaying visual information, and recognizing from the plurality of domains a selection domain corresponding to an input signal inputted through the input unit; a control information recognizing unit, recognizing control information corresponding to the selection domain; and a control information processing unit, processing the control information.

The input unit can comprise at least one from a group consisting of a keypad, a wheel, a scroll, and an infrared sensor.

The selection domain recognizing unit can divide the screen into lattices corresponding to the keypad or to a keypad of a remote control communicating through the infrared sensor.

In case a plurality of control information are included in the selection domain, the selection domain recognizing unit can re-divide the selection domain and one of the re-divided domains can be selected for the control information recognizing unit.

The display unit enlarges and displays the re-divided selection domain, and the enlarged selection domain can be reduced again in accordance with control signal inputted through the input unit.

The selection domain recognizing unit can recognize location information of at least one of the control information corresponding to the screen and divide each domain to correspond to the location information.

In case the screen displays a plurality of windows, the selection domain recognizing unit can divide one selected active window. In addition, each of the plurality of windows can be given an identification code, and a window, in the active window, having an identification code corresponding to an inputted signal can be selected In case the active window has a scroll bar, location information of each of the control information can have an initial value, and control information in accordance with the selection domain can be selected in accordance with the initial value and a displacement value corresponding to the movement of the scroll bar.

The display unit can display a boundary of the divided domain and a letter or number corresponding to the domain.

### DESCRIPTION OF DRAWINGS

FIG. 1 shows a block diagram of a portable terminal providing a lattice-type user interface in accordance with a preferred embodiment of the present invention;

FIGS. 2-4 show examples of the lattice-type user interface in accordance with preferred embodiments of the present invention;

FIG. 5 shows an example of the user interface, in which a plurality of windows are open, in accordance with a preferred embodiment of the present invention;

FIG. 6 shows an example of the user interface, in which the window has a scroll bar, in accordance with a preferred embodiment of the present invention; and

FIG. 7 shows a flowchart of the lattice-type user interface in accordance with a preferred embodiment of the present invention.

### MODE FOR INVENTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents, and substitutes covered by the spirit and scope of the present invention. Throughout the drawings, similar elements are given similar reference numerals.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to the other element, it shall be construed as being connected or accessed to the other element directly but also as possibly having another element in between. On the other hand, if one element is described as being “directly connected” or “directly accessed” to the other element, it shall be construed that there is no other element in between.

The terms used in the description are intended to describe certain embodiments only, and shall by no means restrict the present invention. Unless clearly used otherwise, expressions in the singular include pluralized expressions. In the present description, an expression such as “comprising” or “consisting of is intended to designate a characteristic, number, step, operation, element, part, or combinations thereof, and shall not be construed to preclude any presence or possibility of one or more other characteristics, numbers, steps, operations, elements, parts, or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, preferred embodiments will be described in detail with reference to the accompanying drawings. Moreover, for the convenience of description, the present invention will be described using a mobile terminal such as a mobile phone, but it shall be evident through the below description that the present invention is applicable equivalently to any electronic device, such as a PDA, analog TV, digital TV, desktop computer, or laptop computer, which provides a user interface using display means.

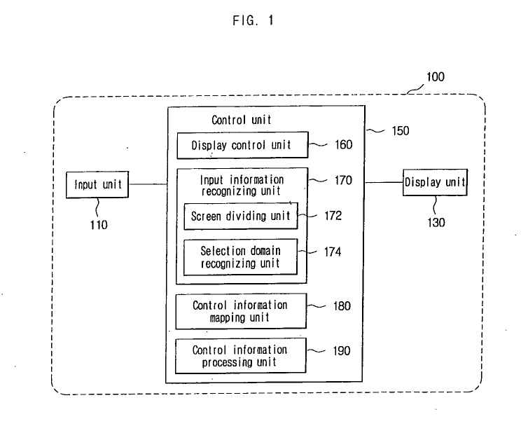

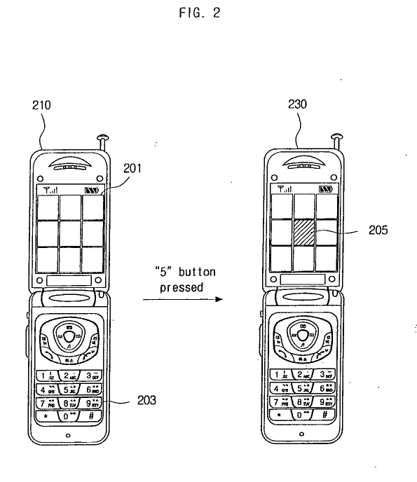

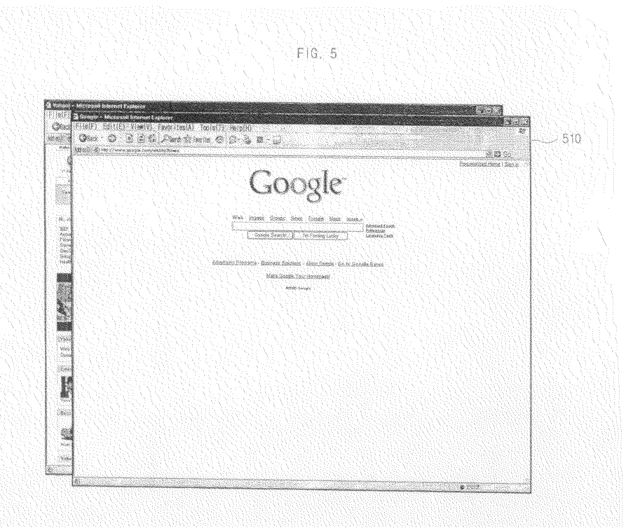

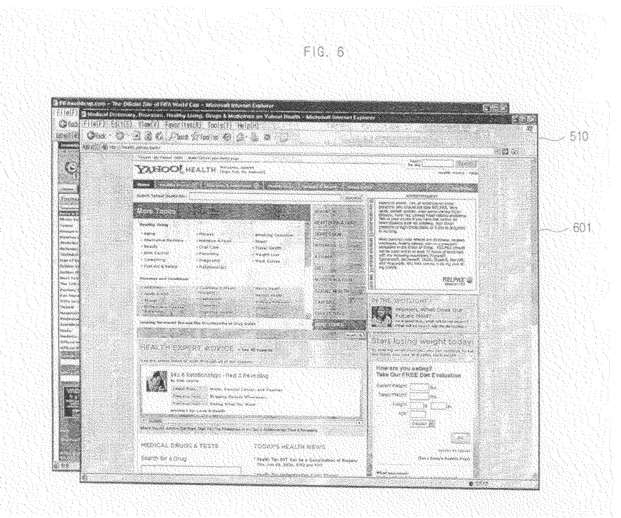

FIG. 1 is a block diagram of a portable terminal providing a lattice-type user interface in accordance with a preferred embodiment of the present invention; FIGS. 2-4 are examples of the lattice-type user interface in accordance with preferred embodiments of the present invention; FIG. 5 is an example of the user interface, in which a plurality of windows are open, in accordance with a preferred embodiment of the present invention; and FIG. 6 is an example of the user interface, in which the window has a scroll bar, in accordance with a preferred embodiment of the present invention.

Referring to FIG. 1, the portable terminal 100 in accordance with a preferred embodiment of the present invention comprises an input unit 110, a display unit 130, and a control unit 150.

The input unit 110 is means for receiving information, such as selection information, from the user. As shown in the accompanying drawings, the input unit can be realized in a button-type keypad 203, and a wheel and a scroll, which are input means receiving directly from the user, as well as an infrared sensor, for receiving a signal from a remote control, can function as the input unit 100.

The display unit 130 is means for displaying the screen and can be, for example, an LCD screen.

The control unit 150 controls the display unit 130 such that the display unit 130 displays a particular screen and a screen corresponding to information inputted through the input unit 110. That is, once information corresponding to a location on a screen displayed on the display unit 130 is selected through the input unit 110, the control unit 150 controls the display unit 130 such that a function (e.g. moving to a linked webpage or providing detailed information) corresponding to the information is carried out.

Below, the user interface in accordance with the present invention will be described.

### Method of Providing a User Interface

The portable terminal 100 in accordance with a preferred embodiment of the present invention displays a latticed section on a screen as a user interface, recognizes a domain in accordance with the information inputted through the input unit 110 by the user, and carries out a function in accordance with the predetermined function corresponding to the domain on the screen displayed through the display unit 130.

Referring to FIG. 2, which is in accordance with a preferred embodiment of the present invention, the portable terminal 100 divides a screen 201 into 9 lattices (refer to reference numeral 210), each of which is linked to the number (1 through 9) of a key on a keypad 203. Thus, selecting a number on the keypad 203 selects a domain 205 on the screen corresponding to the number (refer to reference numeral 230), and the function corresponding to the selected domain 205 is carried out. For example, if the number 5 is located in an icon that links to a webpage, the user can press the number 5 to have the portable terminal 100 recognize the icon on the corresponding location and display the pertinent webpage on the screen. The information, to which a particular predetermined function is set, as in the above example, will be called “control information” hereinafter. The control information can be included in visual information displayed on the screen or the header of the visual information. The control information can provide a result of a particular predetermined function, such as displaying a linked screen (e.g. detailed information display screen and relevant information display screen), moving a location, displaying a map location, phone, fax, e-mail, and playing video. The control information has location information (e.g. 1-D, 2-D, and 3-D coordinates) on a location displayed on the screen. Moreover, the control information can comprise visual information, such as an icon, video, and text, such that the user can visually recognize the control information. Therefore, the user does not have to use a mouse or touch the screen, as in the touch-screen method, to move the cursor to a desired location. The user can simply operate the button corresponding to a location to input the desired selection information.

Here, the information (e.g. a number or a letter) on the corresponding button can be displayed on one side of the domain such that the user can conveniently recognize the button. For example, the number “1” (or the letter “a”) can be displayed on one side of the domain corresponding to the number button “1”.

In another embodiment, each of the divided domains can have a particular translucent color such that the information contained in the domain is still visible. For example, each of the 9 domains can be displayed in red, orange, yellow, green, blue, navy, cyan, and brown, respectively, and the corresponding button on the keypad 203 can be made to irradiate the same color light. Thus, the user can conveniently recognize and operate a desired button by comparing the color on the button and the color of the irradiated light.

The 9 division, shown on the drawing, is merely an embodiment, and the domain can be divided into a number of divisions, including 16 divisions and 25 divisions. Even if the number of divisions exceeds the number of corresponding key buttons, for example 16 divisions, each domain can be selected using the buttons 1 through 9 on the keypad 203. For example, one of the divided domains can be selected by pressing the number button “1” once, and another can be selected by pressing the number button “1” twice. Therefore, although the number of buttons is smaller than the number of divisions, it is possible to select every divided domain.

Here, the number button “0”, which is not used, can be used as the “Enter” button. For example, if the user presses a button (e.g. the number button “5”) corresponding to a desired domain followed by the “0” button, the domain corresponding to the “5” button can be entered as the selection information. Therefore, in case multiple buttons need to be pressed in order to select a domain, the domain corresponding to the information inputted hitherto can be selected by finally pressing the “0” button. Although the “0” button is used in this example, another button, such as the “#” button, “*” button, or a camera function button, which is not used to select any divided domain, can be used.

Of course, it is possible to select the information inputted hitherto, without the use of the Enter button, if there is no input for a predetermined duration (e.g. 1 second) after inputting the information corresponding to a domain.

Separate functions can be linked to buttons other than the Enter button, for example, the “#” button, “*” button, Internet access button, and SMS button. For example, the “*” button can be made to have the portable terminal dial a predetermined number (e.g. the customer service of a shopping mall) or a preconfigured number displayed on the screen. By pressing the “0” button twice, the user can check out the selected merchandise items. If the Internet access button is pressed, comprehensive information on the current screen can be displayed.

The number buttons of a portable terminal, corresponding to the divided domains, in accordance with a preferred invention of the present invention can be simply used as means for inputting numbers and letters, also. Thus, each time a predetermined key (e.g. the “#” button or a separate button on the keypad 203) is pressed, numbers, Korean, or English can be inputted.

According to another embodiment of the present invention, a divided domain can be selected by using the arrow buttons, without using the number button of the keypad 203. When the screen is divided, the cursor is located in a particular domain (e.g. the domain in which the mouse placed the cursor). The particular domain can be indicated by displaying the border with a particular color, such as red, or with a line, such as a dotted line. The user can move the cursor to a desired domain, using the arrow button, and select the domain by pressing the predetermined button (e.g. the “0” button).

The portable terminal 100 in accordance with a preferred embodiment of the present invention can use a predetermined button (e.g. the address book button) or a separate button as a “scrap” button. The scrap function allows the user to scrap the currently-displayed screen, which can be either the entire screen or the control information included in the screen. The user, therefore, can use the control information in the scrapped screen at a desired time. For example, if the user desires to purchase a bag, shown in a broadcast program, the screen of a scene showing the bag can be scrapped. Later, the user can use the control information of the bag on the screen to purchase the bag.

If the latticed domain contains a plurality of control information, the portable terminal 100 must receive only one of the control information. For this, the portable terminal 100 in accordance with a preferred embodiment can have one of the control information selected by the user by recognizing one domain corresponding to the selection information inputted by the user and displaying the control information corresponding to the domain.

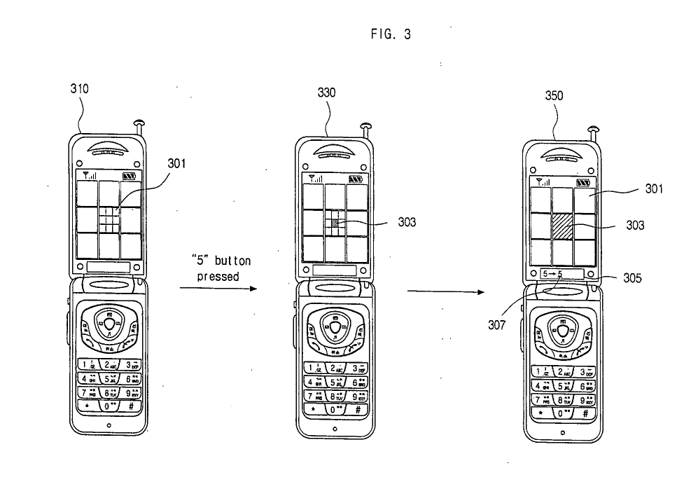

Referring to FIG. 3 in accordance with another preferred embodiment of the present invention, if one domain 301 contains a plurality of control information, the selected domain can be divided again to have one of the subdivided domains 303 selected to receive one of the control information (refer to reference numerals 310 and 330). In this case, the pertinent domain 301 can be enlarged, as shown in reference numeral 350, since the subdivided domain may be too small for the naked eye to identify. The number of divisions and enlargement or reduction of the selected domain can be selected by the user, and selected domain information 305 can be displayed on one side of the screen. The user can move to a desired screen by moving the cursor 307 of the selected domain information 305 using the arrow keys. Of course, the cursor on the selected domain information 305 can be moved after operating a separate function key if the arrow keys are used for inputting selection information. For example, in case the domains are selected in the order of the 5^{th}, 4^{th}, and 8^{th} domain, moving the cursor 307 to the 5^{th} domain with the arrow key moves to a start screen, on which the 5^{th} domain is selected. Any other method for moving the cursor to a divided screen desired by the user can be equivalently applied.

Take an example of locating a subway station (e.g. Gangnam Station) in Korea with the divided screen enlargement function. By successively selecting a domain on a screen, which is divided into 9 domains, the section value (e.g. 1234567) for Gangnam Station can be obtained. Here, the initial basis for the map can be either the entire nation, Seoul City, Gangnam-gu, or Yeoksam-dong. Thus, another person, to whom the section value is sent, can locate Gangnam Station, using the section value and the same map.

Here, dividing the screen into 9 domains is merely one embodiment, and the present invention can be embodied in a number of divisions, including 4 domains, 16 domains, and 25 domains. The user can input selection information, using the input unit 110, such as the arrow buttons, alphanumeric buttons, and special function buttons, and particular control information can be selected and operated according to the inputted selection.

Sometimes, the same control information can be located in a plurality of domains. In this case, the portable terminal 100 can execute the function corresponding to the control information only if the domain covering an area with the largest image of the control information is selected. In another method, the control information can be made to be executed even if only one of the domains containing the image of the control information is selected.

On the other hand, a multimedia terminal, which mostly displays images, does not have much control information on the screen. In this case, division into smaller than 9 domains, for example, 2 domains, 3 domains, or 4 domains, may be sufficient.

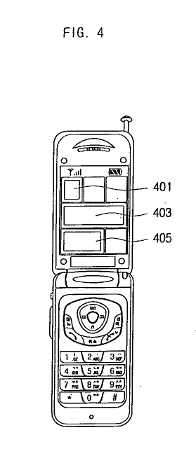

Referring to FIG. 4, which is in accordance with another preferred embodiment of the present invention, the domains can be divided according to control information 401, 403, and 405 included in a current screen. That is, one of the control information 401 can be made to correspond to the “1” button, another one of the control information 403 can be made to correspond to the “4”, “5”, or “6” button. Another one of the control information 405 can be made to correspond to the “7” or “8” button. This kind of screen division can be carried out using the location information of control information that is present in the pertinent screen. This kind of unequal division does not require the lattice in every domain on the screen and can only display the domains in which control information is included.

The domains can be divided into many other forms of lattice. This kind of varying division method can combine domains, which have the same control information, to one domain

It should be also evident, through the above description, that, in case there is a plurality of control information, this information can be combined to and selected as one domain, and one group can be subdivided such that one unit of control information can be selected.

The portable terminal 100 in accordance with a preferred embodiment of the present invention can display the control information corresponding to the selected domain as a text in a balloon or a separate area. Thus, the user can have some information on the control information corresponding to the selected domain before executing the pertinent function.

The portable terminal 100 in accordance with a preferred embodiment of the present invention can have a three-dimensional control by implementing a function of X, Y, and Z coordinates in the divided domain. For example, a particular object in a multimedia image can be controlled by having it divided into a front view and a rear view. Moreover, by implementing a rotation function, a side view, which has Z coordinates, can be displayed as a front view, and a domain can be selected while the object is rotated.

According to a preferred embodiment of the present invention, the portable terminal 100 can display a plurality of windows. In this case, the portable terminal 100 can divide only one active window into lattices, receive control information, and execute the function corresponding to the control information.

Referring to FIG. 5, each window has its own identification code, with which one window (including the desktop) is designated as the active window 510, only in which division can be made. In other words, the user can select one window or the desktop as the active window 510, using the arrow button or a particular function button. In case a plurality of windows (e.g. 2 windows) are open, the user can select a window in the order of opening (e.g. the desktop, first window, second window, etc.), using a predetermined button (e.g., the arrow button or “*” button). If the desktop is set as the active window, the entire screen will be divided, and the rest of the windows will remain open on the desktop, closed on the desktop, or covered by the desktop.

When a window opens, a number can be assigned as an identification code, which is displayed at a location of the window, and the user can set a window as the active window 510 by inputting the number corresponding to the desired window. Through this, when multiple windows, such as the computer screen, two-way TV, etc., open, the identification code can distinguish each window to identify the active window 510, thereby enabling the division within the active window 510 and the identification of control information within each domain.

The homepage of some sites, such as a shopping mall, is not completely visible on the screen, but the screen can be moved left and right or up and down using the scroll bar 601 disposed on the bottom of the window.

Referring to FIG. 6, the user can move the scroll bar 601, using, for example, the arrow button. In this case, the location information of each of the control information in the window changes in accordance with the movement of the scroll bar 601. That is, the initial value based on the location of the control information is predetermined, and the location information based on a displacement value from the movement is calculated. For example, in case the initial value for the location information of one of the control information is (X, Y)=(3, 5), and the displacement value from the movement of the right

scroll bar 601 is Y=5, the location information of the current control information is (X, Y)
=(3, 10).

Therefore, the portable terminal 100 can recognize the control information having location information based on the selection domain of the lattice selected by the user, using the initial value and displacement value.

Referring back to FIG. 1, the control unit 150 can comprise a display control unit 160, an input information recognizing unit 170, a control information mapping unit 180, and a control information processing unit 190, corresponding to each function for providing the user interface in accordance with the present invention.

The display control unit 160 displays a particular screen in order to control the display unit 130.

The input information recognizing unit 170 recognizes a selection domain corresponding to the information inputted through the input unit 110. That is, as described above, the input information recognizing unit 170 divides the currently-displayed screen to a plurality of predetermined domains. The boundaries can be expressed with a particular marking, such as a dotted line or a red line. Of course, it is preferable that the interface function (“lattice input function” hereinafter) in accordance with the present invention is carried out only if an execution command (e.g. pressing a lattice display button (not shown)) for the lattice input function is inputted. In other words, the user interface is provided through the touch-screen method or mouse method during the normal operation, but only when the execution command for the lattice input function is inputted, the screen becomes latticed in order to allow the user to select one of the domains.

The input information recognizing unit 170 comprises a screen dividing unit 172 and a selection domain recognizing unit 174. The screen dividing unit 172 divides the currently displayed screen into a predetermined number or a number inputted by the user. Moreover, the screen dividing unit 172 can divide the screen to correspond to the control information of the currently displayed screen, which is described earlier and hence will not be described again.

According to another preferred embodiment of the present invention, the screen dividing unit 172 can also divide the screen in accordance with division information included in the currently displayed screen. For example, in case broadcast data containing information on a division method is received from an Internet broadcaster and is displayed, the screen may be divided based on the division method. In other words, the portable terminal 100 can extract the division information from the data, which will be displayed on the screen, and divide the screen to match the division information extracted for inputting the selection information.

The selection domain recognizing unit 174 recognizes the domain on the screen corresponding to an input signal inputted through the input unit 110 by the user. As a result, the input information recognizing unit 170 divides the screen and recognizes the selection domain corresponding to the input signal inputted by the user.

The control information mapping unit 180 recognizes control information corresponding to the selection domain recognized by the input information recognizing unit 170. If there are a plurality of control information corresponding to the selection domain recognized by the input information recognizing unit 170, the control information mapping unit 180 orders the selection domain recognizing unit 174 to re-divide for the selection of one of the control information. As a result, the selection domain recognizing unit re-divides the selected domain, recognizes the selection domain corresponding to an input signal inputted later, and provides the selection domain to the control information mapping unit 180.

The control information mapping unit 180 provides control information to the control information processing unit 190 in case one of the control information is recognized in accordance with the selection domain received from the selection domain recognizing unit 174. The control information processing unit 190 carries out a function corresponding to the control information. For example, in case the control information contains a URL of a linked webpage, the data on the webpage is provided to the display control unit 160 such that the webpage corresponding to the URL is displayed on the display unit 130. Since anyone skilled in the art shall understand how the control information is processed, the pertinent description will not be provided herein.

It should be evident that each element of the control unit 150 can perform a pertinent function for the user interface of the portable terminal 100 in accordance with a preferred embodiment of the present invention.

It is not necessary that each element of the control unit corresponding to each function is embodied through hardware, but it should be evident that each element can be embodied through software, such as a program executable by the control unit 150.

Although not illustrated in the accompanying drawings, the portable terminal 100 can further comprise a communication unit, for communicating with an external device through a communication network, and a storage unit, for storing data to be displayed through the display unit 130.

Hereinafter, the process of a portable terminal in accordance with a preferred embodiment of the present invention providing a user interface in accordance with the lattice input function.

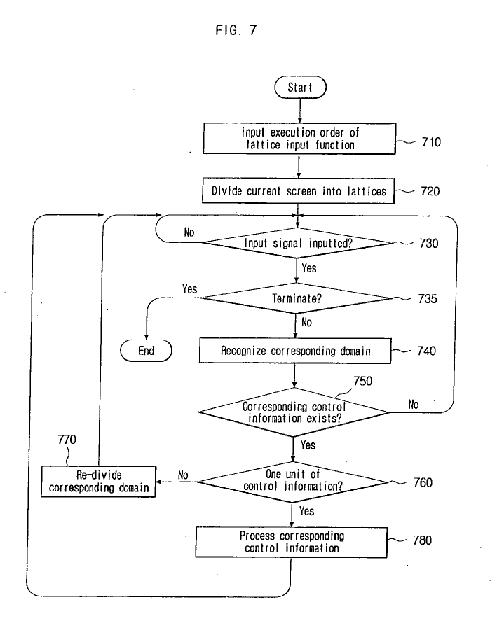

FIG. 7 is a flowchart showing the process of providing a lattice-type user interface in accordance with a preferred embodiment of the present invention.

Referring to FIG. 7, in step 710, the portable terminal 100 receives an execution command corresponding to a lattice input function. If the lattice input function is always carried out, this step can be skipped.

In step 720, the portable terminal divides the current screen to a lattice type screen. The number of divisions can be predetermined or set according to information separately inputted by the user. As described earlier, the screen can be divided variably to correspond to control information of the pertinent screen. In case a plurality of windows are open, the active window becomes divided, as described earlier.

In step 730, the portable terminal 100 determines whether an input signal is received. Once the input signal is received by use of an installed key button (or a key button on the remote control), the portable terminal 100 determines in step 735 whether the input signal is a command to terminate the lattice input function. If it is not a termination order, the portable terminal 100 recognizes a domain, among the divided domains, corresponding to the input signal.

In step 750, the portable terminal 100 determines whether control information corresponding to the domain exists. For example, the portable terminal 100 extracts control information having location information corresponding to the selected domain from control information corresponding to the current screen.

In step 750, if the control information is determined to be absent, the process moves to step 730, and thus the lattice input function of the present invention can be terminated.

If the control information exists, it is determined in step 760 whether one of the control information exists in the selected domain. If a plurality of control information exists in the selected domain, the portable terminal 100 re-divides the domain, in step 770. Then, steps 730 through 760 can be repeated until a single unit of control information is selected. It is possible, of course, without performing step 770, to display a list of a plurality of control information and have one unit piece of control information selected.

If one unit of control information is recognized as a result of the determination in step 760, a function corresponding to the control information is performed in step 780. Then, the process can repeat step 720 or move to the prior step (to the last divided state, in case of a plurality of divisions), or the lattice input function of the present invention can be terminated.

The method of the present invention, described above, can be embodied in a form of a program and stored in a recorded medium (e.g. CD-ROM, RAM, ROM, floppy disk, hard disk, and magneto-optical disk) that is readable in a computer.

The present invention is by no means restricted to the above embodiments, and those of ordinary skill in the art shall understand that many permutations are possible within the scope and spirit of the present invention.

### INDUSTRIAL APPLICABILITY

As described above, the present invention can provide a method and a device for providing a user interface in an electronic device that can input selection information by selecting a domain on a screen, which is sectioned in a predetermined manner.

The present invention can also allow the user to conveniently input selection information by operating a corresponding button such as a number button, linked to a domain of a latticed screen, on a key pad or a remote control.

The present invention can also allow the user to input selection information with the hand holding a terminal, such as a mobile phone or a PDA.

Moreover, the present invention can allow the user to easily select a detailed domain by enlarging a desired domain of a screen.

Furthermore, the present invention allows children and the elderly, who may have difficulty of steadily pointing a screen of an electronic device, such as TV, which is viewed from a distance, to easily and effectively select information on the screen.

Although preferred embodiments of the present invention have been described, anyone skilled in the art to which the invention pertains shall understand that a large number of permutations and modifications are possible without departing the spirit and scope of the invention, which shall be defined by the claims appended below.

What is claimed is:

1. A method of providing a user interface in an electronic device, the electronic device having a display unit, the method comprising:
(a) dividing an entire screen or a part of the display unit into a plurality of domains, the display unit currently displaying visual information;
(b) recognizing from the plurality of domains a selection domain corresponding to an input signal; and
(c) recognizing control information corresponding to the selection domain and processing the control information.

2. The method of claim 1, wherein the screen is divided into lattices corresponding to a keypad, the keypad being placed in the electronic device or on a corresponding remote control.

3. The method of claim 1, wherein the number of divided domains is predetermined, configured to correspond to separately inputted information, or determined by control information inserted to correspond to the visual information.

4. The method of claim 1, wherein the step (a) comprises: recognizing location information of one or more pieces of control information corresponding to the visual information; and dividing each domain to correspond to the location information.

5. The method of claim 1, wherein the step (b) comprises: displaying the divided screen; receiving the input signal; recognizing a selection domain corresponding to the input signal; and displaying the selection domain in a predetermined format.

6. The method of claim 1, wherein the step (c) comprises: determining whether there are a plurality of control information corresponding to the selection domain; and if there are plurality of control information, re-dividing the selection domain, but processing the control information, only if a divided domain having one piece of control information is selected.

7. The method of claim 6, wherein the re-divided selection domain can be enlarged or reduced.

8. The method of claim 1, wherein, in case the screen displays a plurality of windows, one selected active window is divided.

9. The method of claim 8, wherein each of the plurality of windows is given an identification code, and a window, in the active window, having an identification code corresponding to an inputted signal is selected.

10. The method of claim 8, wherein, in case the active window has a scroll bar, location information of each of the control information has an initial value, and control information in accordance with the selection domain is selected in accordance with the initial value and a displacement value corresponding to the movement of the scroll bar.

11. The method of claim 1, wherein each of the divided domains has X, Y, and Z coordinates and is three-dimensionally controlled.

12. An electronic device, providing a user interface through a display unit, the electronic device comprising:
(a) a selection domain recognizing unit, dividing an entire screen or a part of a screen currently displayed through the display unit into a plurality of domains, the display unit currently displaying visual information, and recognizing from the plurality of domains a selection domain corresponding to an input signal inputted through the input unit;
(b) a control information recognizing unit, recognizing control information corresponding to the selection domain; and
(c) a control information processing unit, processing the control information.

13. The electronic device of claim 12, wherein the input unit comprises at least one from a group consisting of a keypad, a wheel, a scroll, and an infrared sensor.

14. The electronic device of claim 13, wherein the selection domain recognizing unit divides the screen into lattices corresponding to the keypad or to a keypad of a remote control communication through the infrared sensor.

15. The electronic device of claim 12, wherein, in case a plurality of control information are included in the selection domain, the selection domain recognizing unit re-divides the selection domain and one of the re-divided domains is selected for the control information recognizing unit.

16. The electronic device of claim 15, wherein the display unit enlarges and displays the re-divided selection domain, and the enlarged selection domain can be reduced again in accordance with control signal inputted through the input unit.

17. The electronic device of claim 12, wherein the selection domain recognizing unit recognizes location information of at least one of the control information corresponding to the screen and divides each domain to correspond to the location information.

18. The electronic device of claim 12, wherein, in case the screen displays a plurality of windows, the selection domain recognizing unit divides one selected active window.

19. The electronic device of claim 18, wherein each of the plurality of windows is given an identification code, and a window, in the active window, having an identification code corresponding to an inputted signal is selected.

20. The electronic device of claim 18, wherein, in case the active window has a scroll bar, location information of each of the control information has an initial value, and control information in accordance with the selection domain is selected in accordance with the initial value and a displacement value corresponding to the movement of the scroll bar.

21. The electronic device of claim 12, wherein the display unit displays a boundary of the divided domain and a letter or number corresponding to the domain.

22. A recorded medium tangibly embodying a program of instructions executable by an electronic device having a display unit to execute a method of providing a user interface of claim 1, the program readable by the electronic device.
